(19) United States
(12) Patent Application Publication
(10) Pub. No.: US 2011/0316808 A1
(43) Pub. Date: Dec. 29, 2011

(54) SINGLE PIECE TYPE CAPACITIVE TOUCH PANEL

(75) Inventor: Chao-Kuo HSIEH, Taipei County (TW)

(73) Assignee: FORTREND TAIWAN SCIENTIFIC CORP., Taipei County (TW)

(21) Appl. No.: 12/844,510

(22) Filed: Jul. 27, 2010

(30) Foreign Application Priority Data
Jun. 23, 2010 (TW) 099120428

(51) Int. Cl. G06F 3/045

(52) U.S. Cl. 345/174

(57) ABSTRACT

A single piece type capacitive touch panel uses an etching process to form a frame on periphery of a transparent substrate. An icon layer is disposed in the frame by printing or sputtering. The icon layer completely fills the frame. In addition, one side face of the icon layer has an optical film. Accordingly, the structure of utilizing the frame to combine the icon layer can greatly increase the visible area, enhance the flatness, and avoid thicker thickness caused by climbing effect on curved corner of the conventional icon layer, or Mura phenomenon caused by the stacked structure at the side of the conventional icon layer.

### BACKGROUND OF THE INVENTION

### Cross-Reference to Related Applications

This non-provisional application claims priority under 35 U.S.C. §119(a) on Patent Application No(s). 099120428 filed in Taiwan, R.O.C. on Jun. 23, 2010, the entire contents of which are hereby incorporated by reference.

### FIELD OF THE INVENTION

The present invention relates to a touch panel, and more particularly to a single piece type capacitive touch panel applies in a projective capacitive touch panel to effectively increase the visible area, enhance the surface flatness and eliminate Mura phenomenon.

### DESCRIPTION OF THE RELATED ART

Referring to FIG. 5, there is shown a structural diagram of a conventional touch panel. As shown in the figure, the external layer of the conventional touch panel in contact with the environment is usually utilizing a reinforced glass substrate 40. After that, a sensing layer is provided to adhere the substrate 40. For example, an ITO (indium tin oxide) is taken as a conductive material. After partially integrating the glass substrate, the substrate is combined to a display panel to form a complete touch display device. An icon layer 50 is usually printed at a periphery of the glass substrate 40 and taken as a black frame to cover lead wires. A protruded structure is exposed to the surface of the glass substrate 40 after printing the conventional icon layer 50. In the current process, the thickness of the icon layer 50 is about 6-8 μm so that an edge of the icon layer is in contact with the glass substrate 40 at right angles. When an optical film 60 is adhered to the glass substrate 40, the thickness of the optical film 60 caused by climbing effect on the periphery of the icon layer 50 will become higher, thus will not easily controlled. Moreover, Mura phenomenon at the periphery of the marked place shown in the figure is generated due to the excess film thickness variation of the stacked structure at the side. Consequently, the image quality of the touch panel is greatly influenced, and the yield rate is also reduced.

In view of the above demands, the inventors provide a single piece type capacitive touch panel to overcome the conventional drawback, which the icon layer 50 is disposed on the glass substrate 40. The present invention uses the alternative technique by etching a frame on periphery of the transparent substrate, and an icon layer is then disposed into the frame by printing or sputtering, and a flattened surface is finally acquired by fully filling the frame within the icon layer. Therefore, the short circuit caused by climbing effect produced by film thickness of stack structure can be controlled effectively, thus increase yield rate and eliminate Mura phenomenon.

### SUMMARY OF THE INVENTION

To achieve the forgoing objective, the present invention provides a new designed single piece type capacitive touch panel. A frame is formed at a periphery of a transparent substrate by using the etching process. An icon layer is disposed in the frame by using printing or sputtering coating to allow the icon layer to fully fill the frame, thereby increasing the visible area, enhancing the flatness. Simultaneously, thicker thickness caused by climbing effect on the conventional icon layer or Mura phenomenon generated by the stacked structure at the side can be avoided.

To achieve the foregoing objective, the single piece type capacitive touch panel of the present invention comprises a transparent substrate and an icon layer. A frame is provided on periphery of the transparent substrate, and the icon layer is disposed and fully filled in the frame, so as to completely flatten the icon layer and a surface of the transparent substrate. The frame is a ring groove formed by etching process.

In summation of the description above, in order to smooth back end process, the single piece capacitive touch panel further comprises an optical film overlapped on one side face of the icon layer, so that the optical film completely covers the icon layer and the transparent substrate.

### BRIEF DESCRIPTION OF THE DRAWINGS

FIG. 1 is an exploded drawing according to a preferred embodiment of the present invention;

FIG. 2 is a cross-sectional drawing according to a preferred embodiment of the present invention;

FIG. 3 is an exploded drawing of adding an optical film according to a preferred embodiment of the present invention;

FIG. 4 is a cross-sectional drawing of adding an optical film according to a preferred embodiment of the present invention; and

FIG. 5 is a structural diagram of a conventional touch panel.

### DETAILED DESCRIPTION OF THE PREFERRED EMBODIMENTS

The foregoing and other technical characteristics of the present invention will become apparent with the detailed description of the preferred embodiments and the illustration of the related drawings.

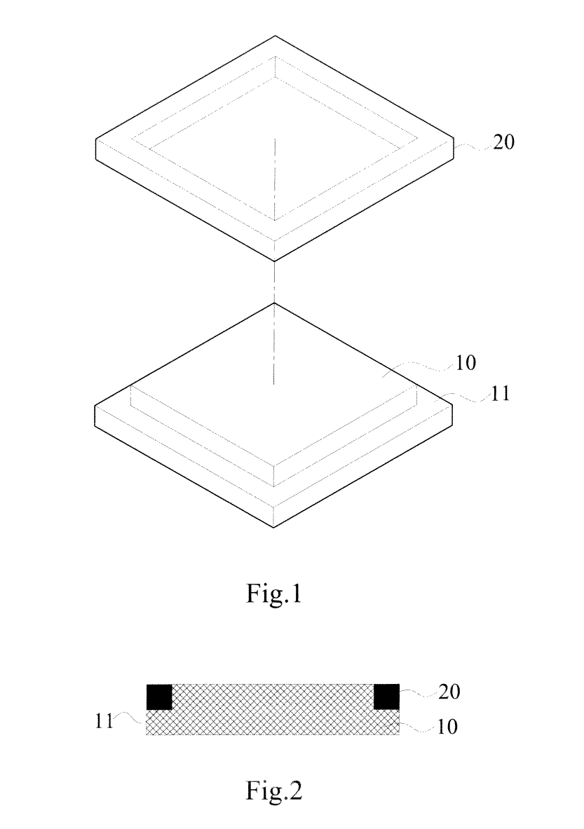

With reference to FIG. 1 to FIG. 2 for an exploded drawing and a cross-sectional drawing in accordance with a preferred embodiment of the present invention, the single piece type capacitive touch panel comprises a transparent substrate 10 and an icon layer 20.

The transparent substrate 10 is selected from one of glasses or polymer plastic. For example, while adopting a glass material, the glass material is firstly cut into a plurality of glasses with small pieces, wherein its thickness is about 0.5-1.1 mm, and a frame 11 is formed at a periphery of a surface of the transparent substrate 10 through etching process. As shown in the figures, the frame 11 is a ring groove and has a depth of about 5-7 μm. Since the transparent substrate 10 has a surface that is directly in contact with the outside, the surface treatment is utilized to achieve goals of protection and scratch prevention. Therefore, the etched transparent substrate 10 is processed with the surface enhancement to hardening the surface chemically. For instance, chemical agents such as glass ionization, potassium nitrate or potassium sulfide, are adopted to immerse the substrate, but the present invention is not limited thereto. The transparent substrate 11 of the present invention can select hydrofluoric acid as an etching solution for etching the substrate.

The icon layer 20 is mainly used for covering signal lead wires at an edge of the touch panel. The icon layer 20 is disposed in the frame 11 at the periphery of the transparent substrate 10 through one such manner of printing or sputtering coating to allow the icon layer 20 to fully fill within the frame 11, thereby completely flattening the icon layer 20 and a surface of the transparent substrate 10. The printing material of the icon layer utilized herein can be implemented by selecting the resin photoresist.

In summation described above, the present invention utilizes etching method to form a frame 11 at a periphery of the transparent substrate 10. The etched transparent substrate 10 then is processed with the surface enhancement. Finally, the icon layer 20 is completely filled inside the frame 11 to allow a surface of the transparent substrate 10 to form a flattened plane. Since the frame 11 is taken as a limit structure, the disposition position and scope of the icon layer 20 can be conveniently controlled, and the visible area can be increased. Moreover, Mura phenomenon produced by climbing effect on conventional icon layer 50 due to higher thickness of optical film of stack structure can thus be prevented.

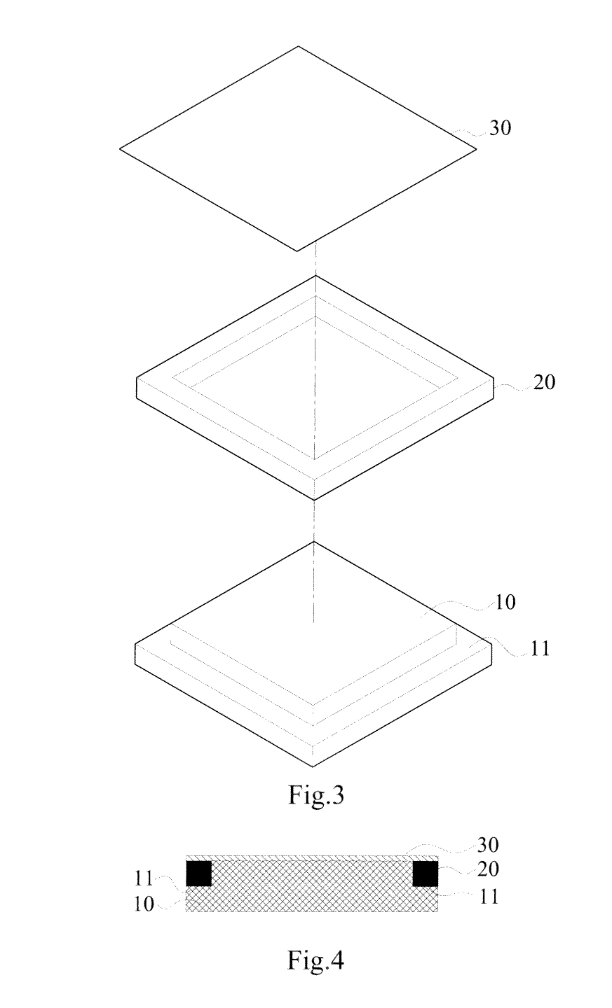

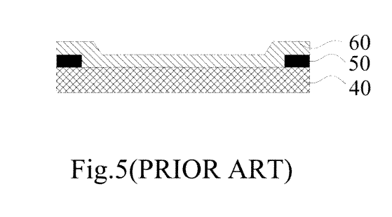

With reference to FIG. 3 and FIG. 4 for an exploded drawing and a cross-sectional drawing of adding an optical film in accordance with the present invention, the structure of the present invention is only a partial structure of the touch panel. For the subsequent process, before performing an ITO (indium tin oxide) process, an optical film 20 can be firstly added to improve worse visual influence of undulation resulted from the circuit aperture that is produced by etching the ITO. The manner of processing the optical film 30 can be implemented by adopting the printing, spraying or coating so that the optical film 30 is overlapped on a side of the icon layer 20, and the optical film 30 completely covers the icon layer 20 and the transparent substrate 10. The single piece type capacitive touch panel of the present invention is mainly to dispose the icon layer 20 on the ring side of the etched transparent substrate 10 to allow the whole structure to form a flatter surface. The subsequent process for the touch panel structure of the optical film or the ITO is identical to the conventional technique, thus will no be described here again.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A single piece type capacitive touch panel, comprising:
a transparent substrate, having a frame one the periphery of one side face of the transparent substrate, and the transparent substrate being treated with surface enhancement; and
an icon layer disposed in the frame and fully filling the frame for completely flattening the icon layer and a surface of the transparent substrate.

2. The single piece type capacitive touch panel as recited in claim 1, wherein the frame is a ring groove formed by etching process.

3. The single piece type capacitive touch panel as recited in claim 1, wherein the surface enhancement is processed by chemical hardening.

4. The single piece type capacitive touch panel as recited in claim 3, wherein the surface enhancement is processed by glass ionization,

5. The single piece type capacitive touch panel as recited in claim 1, wherein the icon layer is fully filled within the frame by printing or sputtering.

6. The single piece type capacitive touch panel as recited in claim 2, wherein the icon layer is fully filled within the frame by printing or sputtering.

7. The single piece type capacitive touch panel as recited in claim 3, wherein the icon layer is fully filled within the frame by printing or sputtering.

8. The single piece type capacitive touch panel as recited in claim 1, further comprising an optical film overlapped one side face of the icon layer so that the optical film completely covers the icon layer and the transparent substrate.

9. The single piece type capacitive touch panel as recited in claim 2, further comprising an optical film overlapped one side face of the icon layer so that the optical film completely covers the icon layer and the transparent substrate.

10. The single piece type capacitive touch panel as recited in claim 3, further comprising an optical film overlapped one side face of the icon layer so that the optical film completely covers the icon layer and the transparent substrate.
